(19) United States
(12) Patent Application Publication
(10) Pub. No.: US 2014/0013923 A1
(43) Pub. Date: Jan. 16, 2014

(54) Temperature and humidity effect elimination for stringed musical instruments

(71) Applicant: BEHRANG MEHRGAN, RANCHO SANTA MARGARITA, CA (US)

(72) Inventor: BEHRANG MEHRGAN, RANCHO SANTA MARGARITA, CA (US)

(73) Assignee: BEHRANG MEHRGAN, RANCHO SANTA MARGARITA, CA (US)

(21) Appl. No.: 13/492,767

(22) Filed: Jun. 8, 2012

Related U.S. Application Data
(60) Provisional application No. 61/494,929, filed on Jun. 9, 2011.

(51) Int. Cl. G10D 3/14

(52) U.S. Cl. CPC G10D 3/143
USPC 84/297 R

(57) ABSTRACT

A solution is described which by meant of thermal expansion keeps the tension of the strings of a stringed musical instrument constant in every temperature and humidity level. Then it nearly eliminates the effect of temperature and humidity changes on the pitch of the stringed musical instruments. Different mechanisms are suggested in order to employ this invention.

This invention is directed to the stringed musical instruments.

### DESCRIPTION OF THE RELATED ART

Stringed musical instruments are sensitive to the change of temperature and humidity. An increase in temperature causes thermal expansion of the strings and the body of the instruments. The body of the most of the stringed instruments is made of wood, which has much lower thermal expansion coefficient comparing with the strings. Then in case of an increase in temperature, the strings have more thermal expansion than the wood. Since both ends of the string are pinned into the wood, higher thermal expansion of the strings comparing with the wood reduces the tension of the strings and consequently reduces the vibration frequency of that string (lower tune). A decrease of temperature causes exactly the opposite effect on a vibrating string. Both increase and decrease of the frequency drive the instrument off the initial tune.

Change of humidity also affects the tune, since higher level of humidity of the body of the instrument expands the volume of the wood, and lower level causes contraction. Wood expansion, which increases the distance of the string ends, increases the tension of the string, and as a result the vibration frequency goes higher (higher tune). Lower humidity has the opposite effect.

Change of the pitch caused by temperature and humidity effect is a big problem for stringed instruments those are being played by a group of musicians. In many cases, during a concert, temperature of the hall may change. Also the presence of crowd breathing in a covered area increases the humidity level over the time. These changes have different effects on different instruments.

Also in some cases, one musical instrument may have 2 different types of strings made of 2 different materials, for example brass and steel. Since these strings have different thermal expansion coefficients, change of temperature affects the tune of each string differently. This phenomenon is also a problem for many musicians. For example, the Persian santur has 72 strings. 50% are made of steel, and the other 50% are made of brass. By the change of temperature for about 4 degrees, the frequency of each set of strings changes differently, so that the difference in the tune of brass and steel strings becomes noticeable.

The current invention is aimed to eliminate the above mentioned effects. There have been a lot of efforts in order to solve this problem using various solutions by many inventors.

Keeping the strings tension constant has been considered by some inventors, by hanging weights to one end of the strings. The hung weights apply fixed tension on the strings. U.S. Pat. No. 1,388,880 and U.S. Pat. No. 1,736,580 can be mentioned. Even since this solution works, but can only be used on few stationary instruments. This kind of instrument cannot be moved easily. Another problem is that both the weight and the additional strings may make unwanted vibrations and noises.

Self tuning, using electronic devices is a solution which has been chosen by many inventors. US patents No. US20030226441, U.S. Pat. No. 7,446,248, U.S. Pat. No. 5,824,929, U.S. Pat. No. 4,803,908, U.S. Pat. No. 6,559,369, U.S. Pat. No. 5,859,378, U.S. Pat. No. 7,678,982, U.S. Pat. No. 5,095,797, etc are to be mentioned.

One of the very popular solutions by the inventors is using spring loaded strings mounted in series connection with the strings, and having visual indicators. It is not actually a self tuning system, but is a way to tune the instrument easily and rapidly. It can help beginners with no tuning skills to tune the instrument. Also during a concert, the musicians can adjust the tune without making noise. U.S. Pat. No. 7,855,330, US20080196571, U.S. Pat. No. 7,888,570, US20110036228, U.S. Pat. No. 4,385,543, US20110011238, U.S. Pat. No. 3,575,078, US20110067548, etc are to be mentioned.

There are many of designs for a guitar neck. The rod inside a guitar neck should not be mistaken by a compensation bar. The main purpose of a guitar neck rod is to keep the neck rigid. While a compensation bar or mechanism limits one degree of freedom for one end of the string, which can move according to the change of temperature.

Use of string plates or external frames for strings is also common especially for pianos. String plates do not act exactly like a compensation bar. A piano string plate is made of cast iron, when the wires are made of carbon steel, and the wound strings are made of carbon steel core with bronze, or copper or brass winding. The thermal expansion coefficient is 11.8×10⁻⁷/° C. for the cast iron string plate, 10.8×10⁻⁷/° C. for carbon steel wires, 19×10⁻⁷/° C. for brass, 17×10⁻⁷/° C. for copper and 18×10⁻⁷/° C. for bronze. Since the difference between the thermal expansion coefficients of strings and cast iron string plate, is much less than strings and wood, a piano is much less sensitive to temperature change than other instruments those do not have a string plate, but still is sensitive.

At the meantime, string plates are actually designed to carry the whole stress applied by the strings and not for tension compensation. When in case of the compensation bar, normally the soundboard or the body of the instrument has to carry some of the load, and the compensation bar should mainly carry the axial loads.

Also another difference of the string plate, with compensation mechanism is that the both ends of the strings are being connected to the string plate, whereas in compensation solution (this invention), at least one end of the string (or in many cases both ends) are connected to the body of the instrument, and the compensation bar only limits one degree of freedom, for one end of the string.

The most important difference of the two solutions (string plate and compensation mechanism) is that a string plate cannot be added to a conventional instrument without affecting the sound characteristics of the instrument. Especially when the slightest changes on the sound box or the shape of the instrument, can affect the sound characteristics. At the meantime a compensation solution (specially compensation bar in the simple form) can become a built in feature with minimum effect on the sound characteristics of a conventional musical instrument. As an example for sound board, the U.S. Pat. No. 3,858,480 can be mentioned. With the solution suggested, the sound characteristics will be completely different with the same instrument but without a soundboard.

### BRIEF SUMMARY OF THE INVENTION

This invention is made to eliminate the temperature and humidity effects on the tune of the stringed musical instruments.

This invention helps keeping already tuned strings, tuned in different environmental conditions, by keeping the tension of the strings nearly constant in all conditions. This is due to the use of a compensation bar or mechanism, which is under influence of the environment temperature, and at the meantime, is not affected by the change of humidity. By right choice of the mechanism and its material, the effect of temperature and humidity can be eliminated.

In this document, all the physical and engineering aspects of this concept will be examined by engineering and physical rules, and will be proven that how it can keep the instrument's tune nearly unchanged at a level which is not recognizable for human, at any temperature and moisture level.

### BRIEF DESCRIPTION OF THE SEVERAL VIEW OF THE DRAWING

FIG. 1: Shows a string, pinned at both ends into the wood. This is not an actual instrument. It's a very simplified vibrating string. The simplified schemes are employed at each stage to emphasize the main points.

FIG. 2: The subject of FIG. 1, is modified by adding a simple compensation bar. This figure is used to illustrate that how the compensation bar can keep the string tension constant.

FIG. 3—This figure illustrates a vibrating string, which also has one bridge.

FIG. 4—The subject of FIG. 3, is modified by adding a compensation bar.

FIG. 5—An alternative configuration for compensation bar

FIG. 6—An alternative configuration for compensation bar with an external compensation bar

FIG. 7—An alternative configuration for compensation bar, with a compensation bar not parallel with the movable side of the string

FIG. 8—An alternative configuration for compensation bar, when the body parts have planks connection. This kind of structure is more rigid and the compensation bar can be designed in a way to only carry the axial loads.

FIG. 9—Compensation bar with two bridges and slider mechanism

FIG. 10—Slider mechanism for an instrument with three bridges and 2 vibrating parts of the string.

FIG. 11—Direct compensation bar

FIG. 12—Direct compensation bar

FIG. 13—Direct compensation bar with elastic support

FIG. 14—Using a mechanism with high transfer ratio for reducing the length of the compensation bar

FIG. 15—Slider solution mechanism for instruments with compensation bar not parallel with the string end

FIG. 16—Different arrangements for sliders

FIG. 17—Normal Violin

FIG. 18—Violin with compensation mechanism connected to the tailpiece

FIG. 19—Detailed part of FIG. 18

FIG. 20—Violin with compensation mechanism connected to the tailpiece

FIG. 21—Violin with compensation mechanism connected to the tailpiece

FIG. 22—Violin with compensation mechanism connected to the tailpiece

FIG. 23—Usage of pulley to provide 1:2 transfer ratio for a stringed musical instrument

FIG. 24—Two compensation solutions for a musical instrument having two sets of strings made of different materials.

FIG. 25—Detailed part of FIG. 24.

FIG. 26—An instrument with non-equal length strings

FIG. 27—Illustration of the method to calculate the length of the compensation bars for an instrument with non-equal strings.

FIG. 28—Detailed part of FIG. 27

FIG. 29—A compensation mechanism with sliders, a compensation bridge and connecting rods for a musical instrument with non-equal strings.

FIG. 30—The standalone compensation mechanism of the subject of FIG. 29.

FIG. 31—An arrangement for connecting 3 compensation bars to a single bridge for an instrument with unequal strings.

FIG. 32—An arrangement for compensation mechanism of an instrument with unequal strings, having a compensation bridge for hitch pins, and elastic support for the compensation bars.

FIG. 33—The subject of FIG. 32, with mounted strings.

FIG. 34—A compensation mechanism for an instrument with unequal strings, and having 2 sets of strings, made of different materials (Like the Persian santour).

FIG. 35—Compensation solution for a musical instrument with unequal length strings, like a musical instrument with a neck (A guitar for example), whereas a single compensation bar, does the compensation of the different unequal length strings connected to different spots of the compensation bar.

FIG. 36—Table of calculations for temperature compensation solution.

FIG. 37—Table of calculations for temperature compensation solution.

FIG. 38—Table of calculations for humidity compensation solution.

### DETAILED DESCRIPTION OF THE INVENTION

FIG. 1 shows a free vibrating string 7 pinned into a wooden body 8 at both ends. One end is connected to the hitch pin 2, and the other end is connected to the peg 3. FIG. 2 shows the same string but with compensated solution. The wooden body has been cut into 2 pcs, and the body parts are connected by the compensation bar 5. The relative distance of the peg 3 and the hitch pin 2, will change due to thermal expansion or contraction of the compensation bar 5. In article 1.1, it will be proven that this solution can keep the string tension constant at any temperature.

In article-1.2, it will be proved that keeping the string tension unchanged, will keep the frequency changes under the jnd (Just recognizable difference) level.

The reference numbers shown here are the same on all figures. The compensated string 1, the hitch pin 2, the tuning pin (or peg) 3, the instrument main body in the compensated solution 4 and the second part of it 4B, compensation bar 5, compensation bar screws 6, non compensated string 7, and the body of non compensated instrument (traditional solution) 8.

Article 1.1: In this article, it will be proved that by the suggested solution, the string tension will actually not change under the influence of temperature and humidity change. We proceed with an example and actual numbers, and calculate the string tension at 2 different temperatures:

### Example 1

(FIG. 2): For this case, both the compensation bar 5 and the string 1 are chosen from the same material. In this case the material is brass. When both components are chosen from the same material with 1:1 force transfer ratio (Both parallel and connected as shown in FIG. 2), both components should have the same effective length. The initial temperature is 0° C., and the temperature will be increased to 50° C. Both are numbers are extreme conditions. Its intended to show that the string tension will not change by the change of temperature by 50 degrees. The thermal expansion coefficient is considered to be constant for the whole range. In actual conditions, the thermal expansion is not the same in all this range. But since at each temperature is the same for the string and the compensation bar, we can work with the average number. Diameter of the bar is D_{1.bar}=10 mm=0.01 m, Diameter of the string is Diameter: D_{1.string}=0.43 mm=0.00043 m. For both components Density is ρ=8400 kg/m^{2 z}, The young's modulus is E=110 Gpa=110,000 N/mm², String tension is T₁=70.777911 N (T: Tension), The coefficient of thermal expansion for brass is considered α_{L.brass}=19×10⁻⁷/° C., effective Length of the bar and string: L₁=547.5 mm=0.5475 m (Under the load of T=70.777911N)

Note: This data provides actual string vibration frequency of 220 Hz. Detailed calculation of this number is provided in example 2.

For this example, different conditions of the components are labeled as following: Condition 0 (zero): Before mounting the strings (No load). It should be noted that when the string is mounted on the string and tuned, it is stretched and will become longer. Also when we tune the string, and put some load on the compensation bar, it becomes shorter. So the length of the effective part of the string before mounting it on the instrument is labeled as condition 0 (zero). Example: Effective length of the bar before mounting the string on the instrument: L_{0.bar}

Label for the condition of the components after mounting the string and tuning it is 1 (one). Example: Length of the effective part of the string when mounted on the string and tuned: L_{1.string}. It's obvious that L_{1.string} is longer than L_{0.string}, because it is stretched, keeping in mind that the part of the strings which is wounded around the peg does not count. Only the effective part of the string (the part which can freely vibrate) is considered in calculations.

Label for the components after the temperature change, but not loaded is 2.

Label for the components, mounted and after the temperature change is 3

The initial data of this example shows the parameters in condition 1. In order to prove the claim, parameters for conditions 3 should be calculated. It will be shown that after the change of temperature, the string tension in condition 3 will be the same as condition 1.

Calculation of the parameters in Condition 0: The actual size of both string and bar should be calculated with no load.

Calculation of the mechanical stress on the bar and the string:

σ_{1.bar}=T/A_{bar}=T/(D_{bar}²/4×=π)=70.777911/(10²/4×π)=0.901172 (N/mm²)

σ_{1.string}=T/A_{string}=T/(D_{string}²/4×π)=70.777911/(0.43²/4×π)=487 (N/mm²)

### (A: Area, D: Diameter, L: Length))

ε_{1.bar}=σ_{bar}/E=0.901172/1100000=8.19248E−06

ΔL_{1.bar}/(L_{1.bar}+ΔL_{1.bar})→ΔL_{1.bar}=ε_{1.bar}·L_{1.bar}/(1−ε_{1.bar})

ΔL_{1.bar}=4.48542E−06 m

L_{0.bar}=L_{1.bar}+ΔL_{1.bar}

L_{0.bar}=0.547504485 m

ε_{1.string}=σ_{string}/E=487/1100000=0.00443076

ΔL_{1.string}/(L_{1.string}−ΔL_{1.string})→ΔL_{1.string}=ε_{1.string}·L_{1.string}/(1+ε_{1.string})

ΔL_{1.string}=0.00241514 m

L_{0.string}=L_{1.string}−ΔL_{1.string}

L_{0.string}=0.54508486 m

Now the effect of the heat on L⁰ of both components (both components without load) should be calculated (Condition 2): Condition 2, indicates the effective length of string and bar, at 70 degrees Celsius when the string is not mounted on the instrument (no load).

L_{2.bar}=L_{0.bar}·(1+α_{L.brass}×Δt)=0.547504485×(1+(19×10⁻⁷)×50)

L_{2.bar}=0.548024615 m

L_{2.string}=L_{0.string}·(1+α_{L.brass}×Δt)=0.54508486×(1+(19×10⁻⁷)×50)

L_{2.string}=0.54560269 m

Final stage is calculating T³ of the components (when string mounted on the instrument), which needs calculation of L³ of the components. In order to calculate L³ of the components, it should be kept in mind that T³_{bar}=T³_{string} (Note: Change of the section of the components is not considerable and will not be effected.)

T_{3.bar}=T_{3.string}

σ_{3.bar}·A_{bar}=σ_{3.string.}A_{string}

E·ε_{3.bar}·A_{bar}=E·ε_{3.string.}A_{string}

ε_{3.bar}·A_{bar}=ε_{3.string.}A_{string}

ΔL_{3.bar}/L_{2.bar}·A_{bar}=ΔL_{3.string}/L_{2.string}·A_{string}

ΔL_{3.bar}/L_{2.bar}·A_{bar}=ΔL_{3.string}/L_{2.string}·A_{string}

(L_{2.bar}−L_{3.bar})/L_{2.bar}·A_{bar}=(L_{3.string}−L_{2.string})/L_{2.string}·A_{string}

(L_{2.bar}−L₃)/L_{2.bar}·A_{bar}=(L₃−L_{2.string})/L_{2.string}·A_{string}(L_{3.bar}=L_{3.string})

L₃=L_{2.bar}·L_{2.string}·(A_{bar}+A_{string})/(A_{string}·L_{2.bar}+A_{bar}·L_{2.string})

L_{3.bar&string}=0:548020125 m

ΔL_{3.bar}=L_{2.bar}−ΔL_{3.bar}

ΔL_{3.bar}=4.48968E−06 m

ΔL_{3.string}=L_{2.string}−ΔΔL_{3.string}

ΔL_{3.string}=0.002417435 m

ε_{3.bar}=ΔL_{3.bar}/L_{2.bar}

ε_{3.bar}=8.19248E−06

ε_{3.string}=ΔL_{3.string}/L_{2.string}

ε_{3.string}=0.00443497

σ³_{bar}=E·ε_{3.bar}

σ³_{string}=0.901172356 N/mm²

σ³_{string}=E·ε_{3.string}

σ³_{string}=487.8466574 N/mm²

A_{3.string}=A_{1.string}/L_{1.string}×L_{2.string}

A_{3.stringg}=0.145082292 mm²

T₃=σ³_{string}·A_{3.string}

T₃=70.777911 N=T1

So with 50 degrees of temperature change, there is no change on the tension of the string.

### Example 2

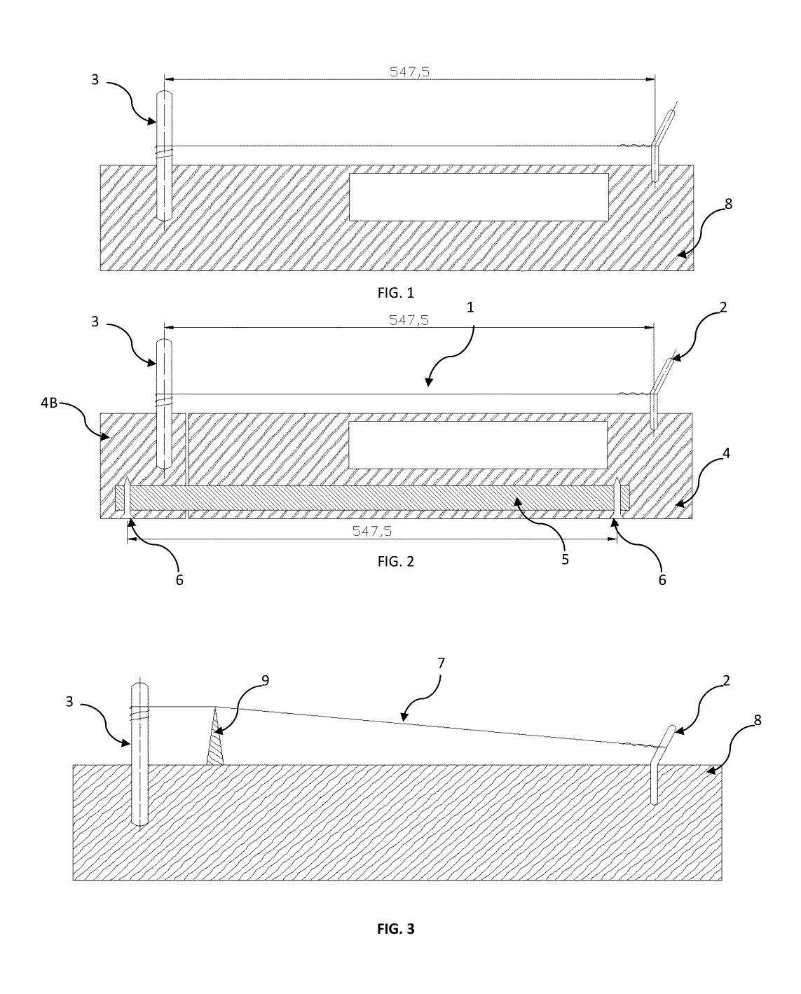

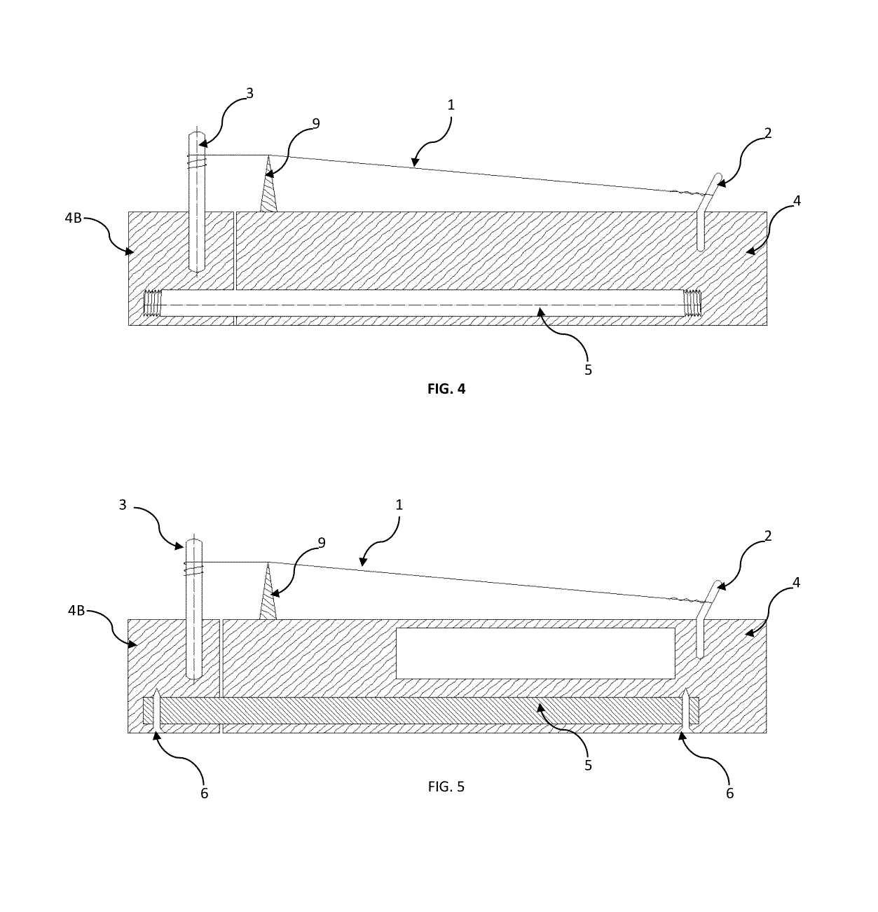

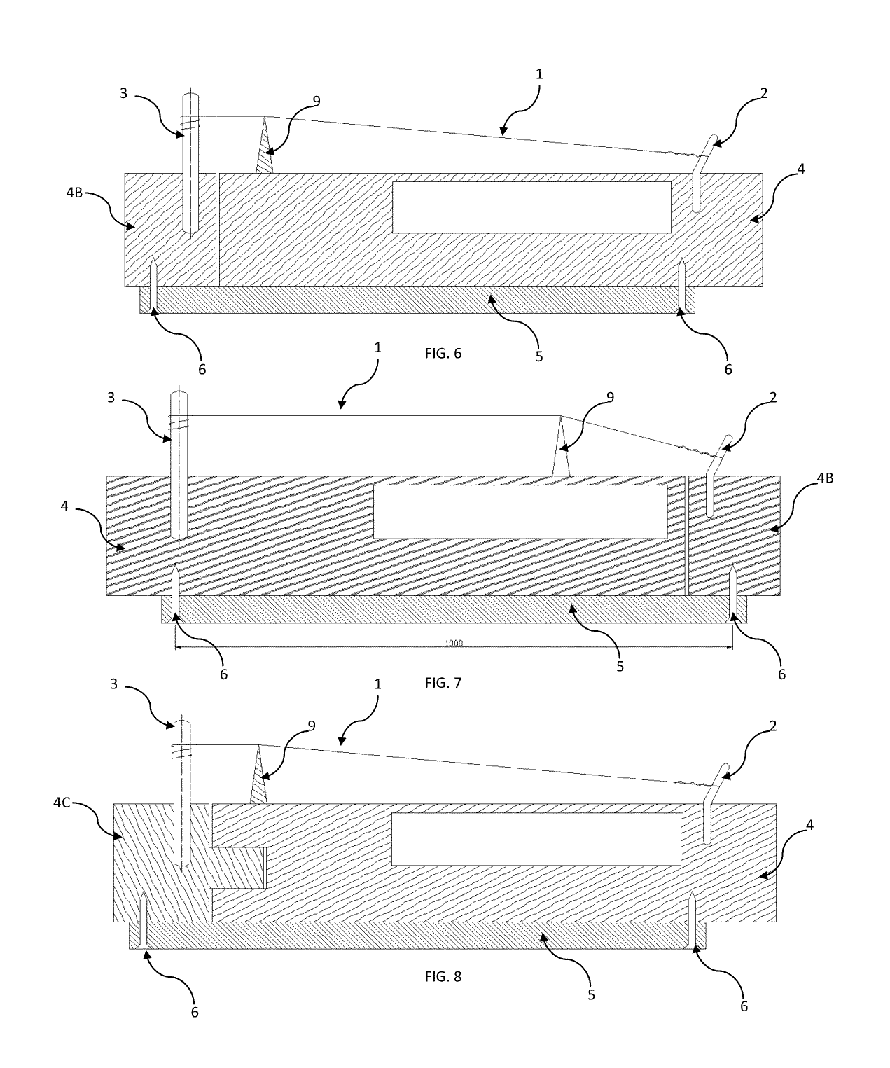

Frequency calculations for a compensated, and a non-compensated string. Example 2, is based on an actual instrument in order to prove how the effect of temperature is compared between a compensated, and a non compensated string. This example is subjected to FIG. 3, and FIG. 4. This instrument has a bridge between to pins. The desired frequency is subjected to the right part of the string, between the bridge 9, and hitch pin 2. So in case of this example, also thermal expansion or contraction of the wood also should be calculated. Because after the temperature change, the new effective length of the string will be distance between the bridge 9 and tuning pin 3, which is effected by the change in the length of the wood. String material: Brass (Thermal co-efficient is 19×10−6/C.° at 20° C.), instrument body material: Wood (Thermal co-efficient is 5×1θ 6/C.° at 20° C.), L (Length of the string)=547.5 mm, D (String's diameter)=0.43 mm (Measured diameter at T=70.7779N), Density of the material=8400 kg/cu·m, T (Tension of the string)=70.7779 N, Frequency of a vibrating string can be calculated by the use of the following formula:

$$f = \frac{v}{2 L} = \frac{1}{2 L} \sqrt{\frac{T}{μ}}$$

where T is the tension, μ is the linear mass, and L is the length of the vibrating part of the string. According to the above mentioned data, the following amounts can be calculated. Weight of the effective length of the string: 668×10−6 kg

μ₀=668×10−6/0.5475=0.0012196 kg/m

f₀=1/(2×0.5475)×(70.778/0.0012196)̂(0.5)=220.00 hz

In this case, the jnd (Just recognizable difference) is considered to be 0.53 hz (equal to 4.3% of semitone)

The stress analysis of the string is necessary to proceed with this problem: The section area of the wire is: 0.145193 mm, The stress applied on the string section is calculated as following:

$$σ = \frac{F}{A} ,$$

In This case, since we are talking about a string, the formula can be turned to:

σ=T/A

Stress=Tension/section area=7.778/0.145193=1203 N/mm̂2

Frequency of the same string will be calculated, when temperature goes 1.7 degrees higher. Thermal expansion co-efficient of brass is 19×10−6. Thermal expansion co-efficient of wood is 5×10−6. Linear thermal expansion of the wood and string will be calculated separately using the following formula:

ΔL_{brass}=α_{L-brass}·ΔT·L=19×10−6×1.7×0.5474=1.76843E−05

ΔL_{wood}=σ_{L-wood}·ΔT·L=5×10−6×1.7×0.5474=4.65375 E−6

Net ΔL=ΔL_{brass}·ΔL_{wood}=1.30305 E−05 m

This difference between expansion of the wood and expansion of the string makes the string loosen. Speaking in engineering words, it reduces the wire tension and consequently reduces the engineering stress of the string, those both can be calculated:

ε=Net ΔL/L₀=1.30305 E−05/0.5474=0.0000238

E_{string}=110 Mpa=110,000 N/mm²

Δσ=ε·E=(2.38 E−5)×(110,000)=2.618 N/mm²

F=T=σ·A

ΔT=Δσ·A=(2.618)×(0.145192725)=0.380114554

So the new tension of the string is going to be:

T₁=T₀+ΔT=70.7779−0.3801=70.3978

The effective L, will become L₀+ΔL_{wood}=0.5475+4.65375 E−6=0.547504654 m

μ₁=668×10−6/0.547504654=0.00121961

According to the new numbers, using the same method of the first part of the problem, the frequency can be calculated and its 219.41 Hz. It is 0.59 Hz lower and exceeds the jnd (0.53 Hz). So as it can be seen, only 1.7 degrees of temperature increase can make the string off the pitch, to an amount which is recognizable for the human's ear!!

F_{noncompensated}=1/(2×0.547504654)×(70.3978/0.00121961)̂(0.5)=219.41 hz

In case of compensated string tension solution, the tension will remain equal to T₀ so with the new Length (L₁) frequency will be calculated:

F_{compensated}=1/(2×0.547504654)×(70.7779/0.0012196)̂(0.5)=219.9981 Hz. It's only 0.0019 Hz

The result is lower than F₀ and far lower than the jnd (0.53 Hz). It will be shown below that for the compensated solution, 50 degrees of temperature increase will change the frequency to 219.945, which is 0.055 Hz, and still far lower the jnd (0.53 Hz). All the above-mentioned formulas have been put into an excel file, and afterward, the output data will be copied instead of writing all the formulas and calculations.

However if the instrument only has strings made of brass, and someone is playing it alone, since the temperature change affects all the strings, the change of pitch may not be noticed.

But if another instrument with steel strings (which has lower thermal expansion co-efficient) plays at the same time, at 4.4 degrees Celsius of temperature change, the pitch difference will become noticeable.

The instrument that is examined in this case has both brass and steel strings for different octaves. So by the change of 4.4 degrees Celsius of temperature, the same note on 2 different octave of the same instrument will not match and the pitch difference is noticeable.

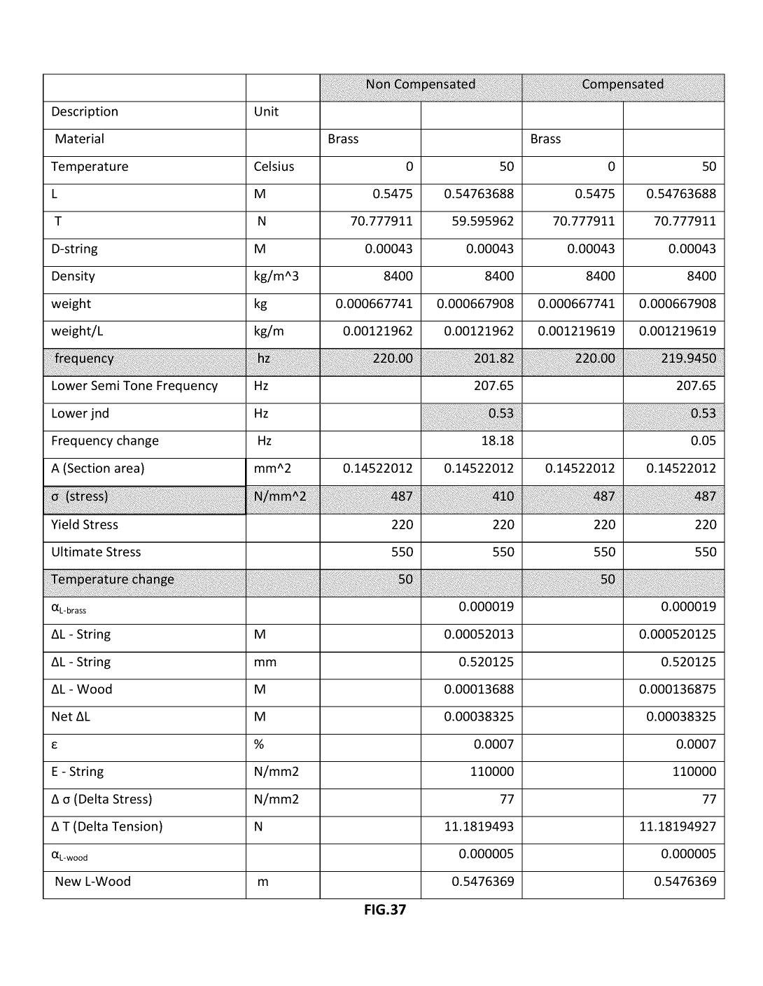

FIG. 37 shows the thermal effect in case of increasing temperature from 0 degree centigrade, to 50 degrees.

Note: The thermal expansion does not act linear by the change of temperature. The thermal expansion co-efficient is not a fixed number and varies in different temperatures. The stated amount for this example is the thermal expansion co-efficient at 20 degrees, and considered as average amount. Then the actual data may vary a little but the whole concept of compensation will be valid since the coefficient is the same for both string and the bar at any temperature.

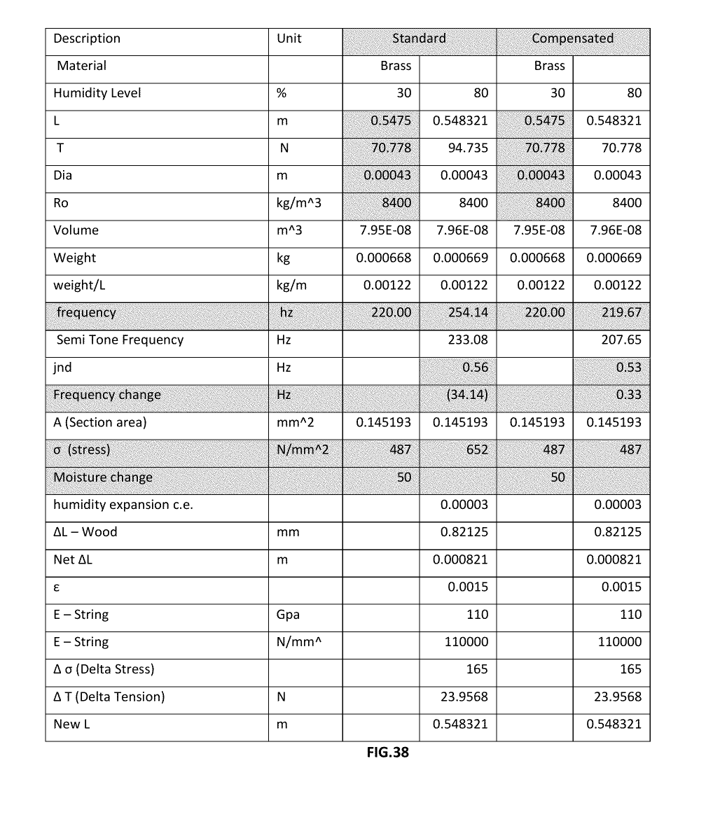

Humidity effect compensation: Humidity will increase the size of the wooden parts. So since normally both ends of the string are pinned into the wood, increase in the size of the wood will stretch the string, and actually increase the tension and consequently the frequency of the string's vibration. Decrease in moisture level will have opposite effect. Compensation bar, in this case, as usual keeps the tension level unchanged and consequently the effect of wood dimension change on the pitch of the string will be below the jnd. FIG. 38 shows how the humidity effects the vibration of a non-compensated, and a compensated string.

It should be emphasized that the change of moisture level inside the woods, highly depends on the processes done to prepare the wooden parts of the instruments. These parts are normally well dried, and have coatings and absorb the least moisture. For this example, the change of moisture percentage inside the body, is considered to be 50% which is very extreme and unlikely to happen. The “Humidity expansion coefficient” is considered to be 3E−5.

It should be considered that in most of the cases, the string is not straight between 2 pins like the one of FIG. 1. Nearly all the stringed instruments at least have 1 or 2 bridges for the strings. Hereafter, some solutions will be shown for the stringed instruments with different geometries. The geometry of the instrument should be considered for choosing the right compensaton solution.

For the solution with 1 compensation bar with transfer ratio 1:1 (Directly connected), the best mounting configuration is to choose the moving side of the body, where the string can be parallel with the compensation bar. FIG. 4 shows a 1:1 ratio compensation bar, pinned in 2 places to the body of the instrument.

Planks type combination of the parts, helps keeping them aligned. In order to keep the figures as simple as possible, this kind of combination is not used for the pictures shown in this file. But for all the solutions where the body is divided into 2 parts, the planks type connection of the parts is the best solution.

The compensation bar can even be not parallel with the movable side of the string as shown in FIG. 7. In this case, the cosin of the angle between the string 1 and the compensation bar 5 should be considered in calculations. And since this way the angle will change with the changes in the length of the compensation bar, system will only be accurate for limited range of temperature, and will not act well for higher range of temperature change. In any case, for example in case of brass, a 50 cm string, will have only 0.5 mm of length increase over 50 degrees Celsius of temperature change. It means that angled compensation bar, can have acceptable feedback for normal temperature changes.

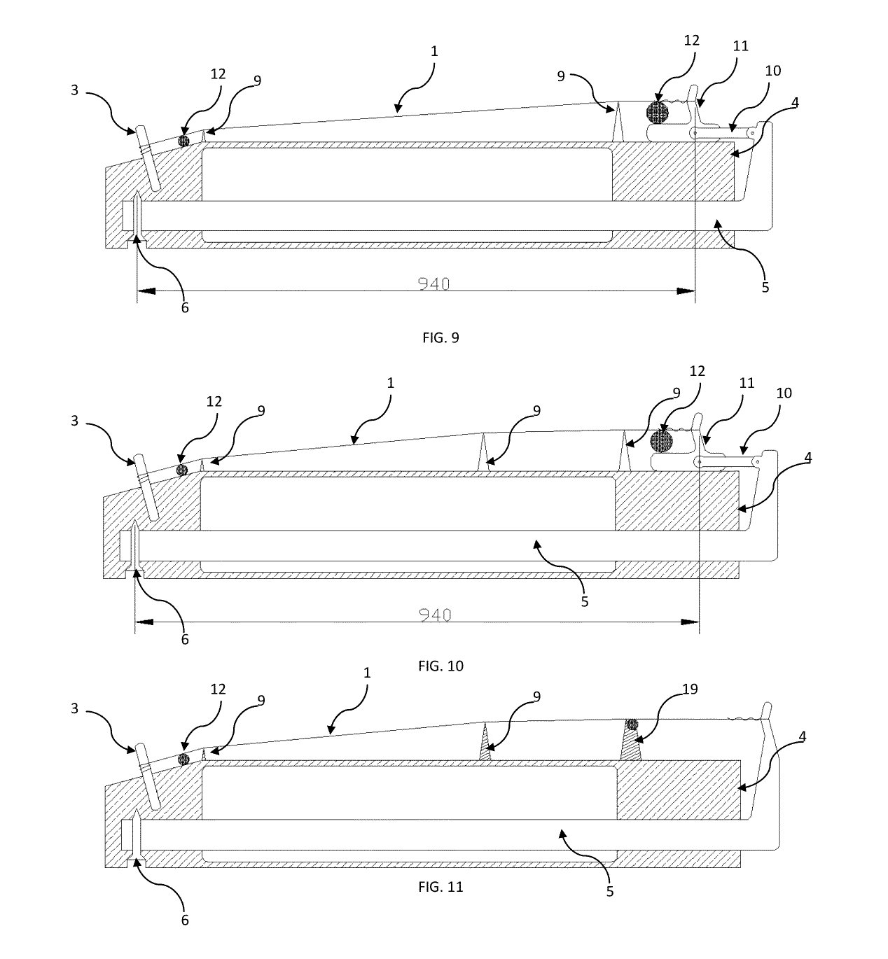

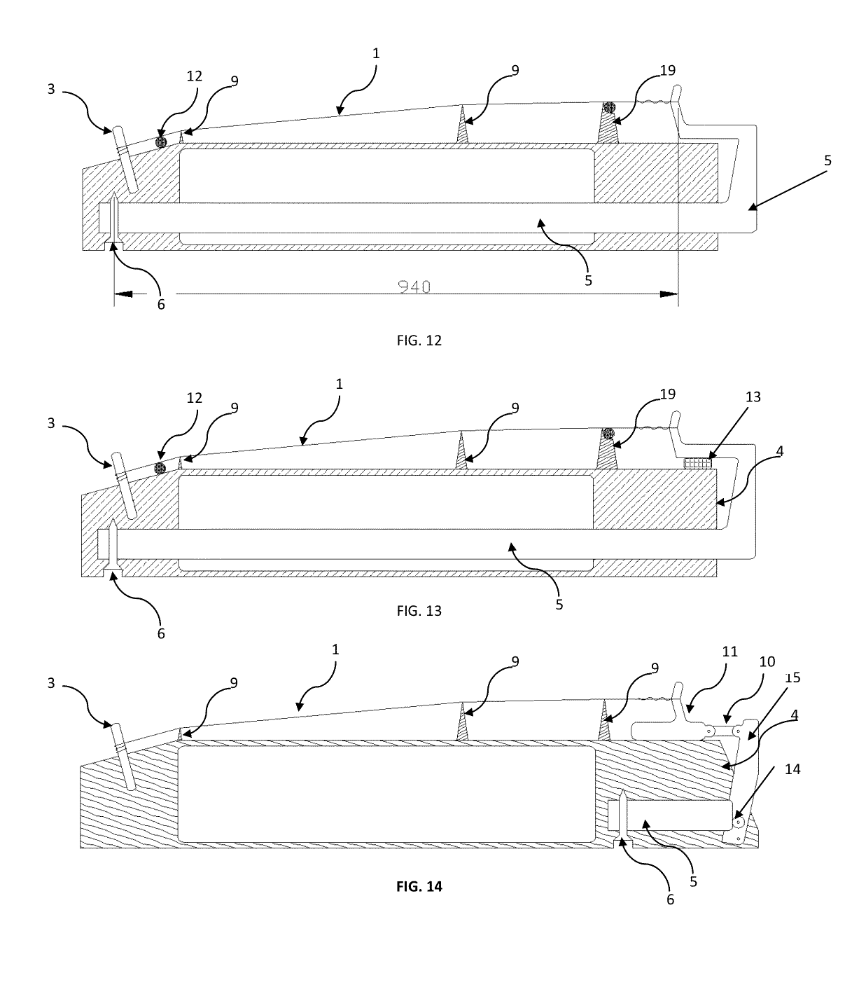

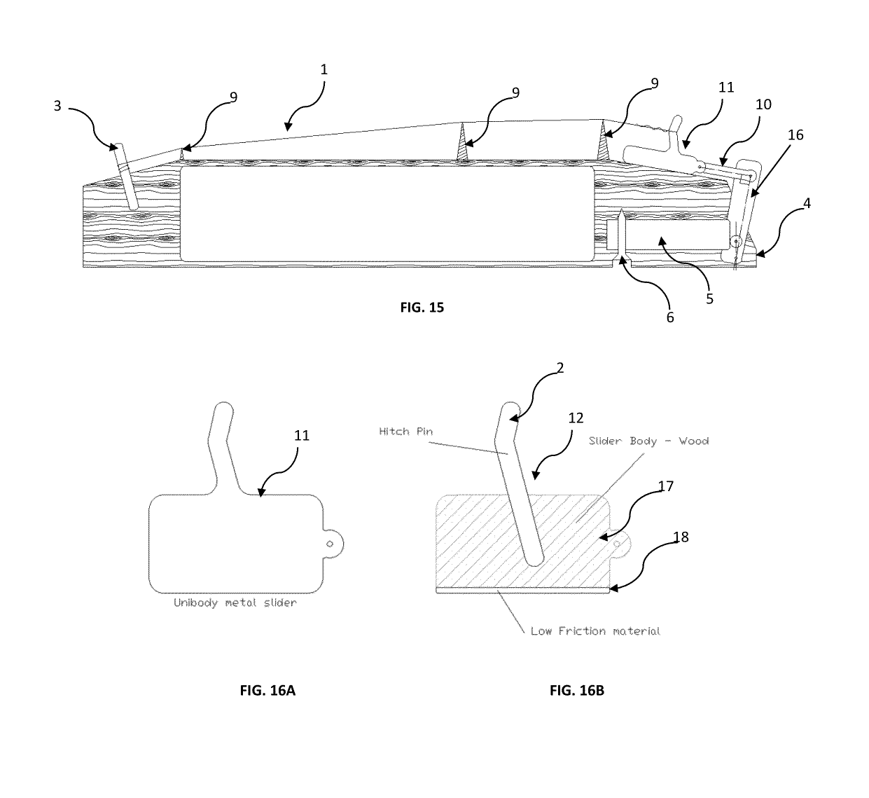

The slider mechanism (FIG. 9, FIG. 10, FIG. 14, FIG. 15) is a perfect solution when a unibody instrument is desired. In any case, all the metal parts should be damped with proper dampers and in some cases damping sleeves in order not to make unwanted vibrations during playing the instrument. Also the unused parts of the string should properly be damped for all the solutions when required. This document is desired to illustrate the mechanisms and the drawings of no focus on the way of dampening the components. Different designs of damping components should be done according to the application. In various figures, schematic dampers 12 are employed to damp the unused parts of the string. Damper can be placed either on the slider as shown on FIG. 9 and FIG. 10, or on the bridges as shown in FIG. 11 and FIG. 12. or on the instrument body as shown on FIG. 12 and FIG. 13.

The issue of damping is not a main issue of this invention and should be done according to the construction of each instrument.

Each slider/compensation mechanism/compensation bar can be used for 1 or multiple strings of the same length, if the strings have the same thermal expansion co-efficient.

FIG. 14 Illustrates a solution where the transfer ratio of the mechanism is around 1:7. Which means 0.1 mm of the increase in the length of the compensation bar, will move the slider 0.7 mm. Since slider 11 movement is parallel to the compensation bar 5, all the 3 pins of linkage 15 are located on 1 line. Unlike this, as can be seen in FIG. 15, when the slider 11 motion is not parallel to the compensation bar 5, the position of the upper pin of linkage 16 is chosen in a way, that the line crossing the end pins of linkage 17 is perpendicular to the line crossing the end pins of linkage 16. This way the actual transfer ratio will be nearly constant in small rotations of linkage 16. On Both FIG. 14 and FIG. 15, the roller 14 is employed in order to maintain the contact with the horizontal compensation bar 5.

Sliders can be made, both from unibody formed material (FIG. 16A), preferably the same material of the strings and compensation bar (ex. Brass, steel, etc.), or be made of wooden body 17 with a hitch pin 2 (FIG. 16B). The later is suggested to be a composite of a wooden part 17, and a low friction layer 18 as shown in FIG. 16B in order to guarantee low resistance against compensation bar force. In both cases, the linear thermal expansion of the components should be calculated for choosing the right length of the compensation bar.

In general, considering the above mentioned fact, when the compensation bar and the movable end of the string are parallel, the thermal expansion of the string, should be equal to the total thermal expansion of wood and compensation mechanism.

L_{1.string}·α_{L.string}·Δt=(L_{1.wood}−L_{1.bar})·α_{L.wood}·Δt+L_{1.bar}·α_{L.bar}·Δt·i

It can be simplified and then the following equation can be used for calculation of the size of the compensation bar:

L_{1.string}·α_{L.string}=(L_{1.wood}L_{1.bar})·α_{L.wood}+L_{1.bar}·α_{L.bar}·i

L_{1.string}·α_{L.string}=L_{1.wood}·α_{L.wood}·L_{1.bar}·α_{L.wood}·L_{1.bar}·α_{L.bar}·i

L_{1.bar}=(L_{string}·α_{L.string}−L_{1.wood}·α_{L.wood})/(α_{L.bar}·i−·α_{L.wood})

The L_{1.wood} is actually the distance between 2 pins of the string, which is equal to the shadow of the string on the body of the instrument. It refers to the transfer ratio of the mechanism. When it is not equal to 1, like FIG. 14 and FIG. 15 the amount of (L_{1.wood}−L_{1.bar})·α_{L.wood} becomes important. In many cases like FIG. 8 the amount of (L_{1.wood}−L_{1.bar})·α_{L.wood} becomes negative but very close to zero. It can even be ignored in many cases.

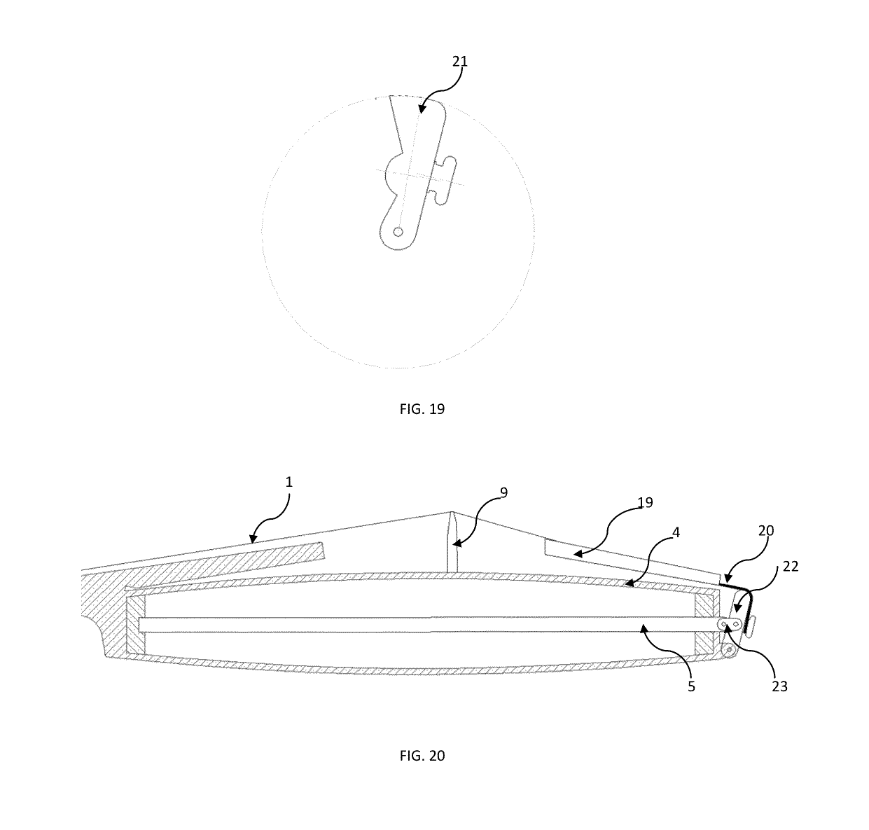

Generally, since in nearly all the instruments, the string is almost parallel to the instrument body, when the i=1, the L_{1.wood} is nearly equal to L_{1.bar}. So (L_{1.wood}−L_{1.bar}) can considered to be zero. The most important thing to remember is that when the amount of (L_{1.wood}−L_{1.bar}) is considerable, especially when the transfer ratio is higher than 1, like the solutions shown on FIG. 14 to FIG. 23, the solution is only a temperature compensator and cannot eliminate the humidity effects. That's because the relative distance of the pins can change by the expansion and contraction of the wood.

In places where the humidity compensation is vital, and the strings are not parallel to the instrument body, with the choice of the ratio=1, and (L_{1.wood}−L_{1.bar})=0→L_{1.wood}=L_{1.bar}, the formula will become:

L_{1.string}·α_{L.string}=L_{1.wood}·α_{L.bar}→α_{L.bar}=L_{1.string}·αL_{1.string}/L_{1.wood}

So the material of the compensation bar can be chosen from a material to have the thermal expansion coefficient of α_{L.bar} (Or as close as possible). In any case (L_{1.wood}−L_{1.bar}) can be considered zero in case of nearly all the actual instruments, and where i=1.

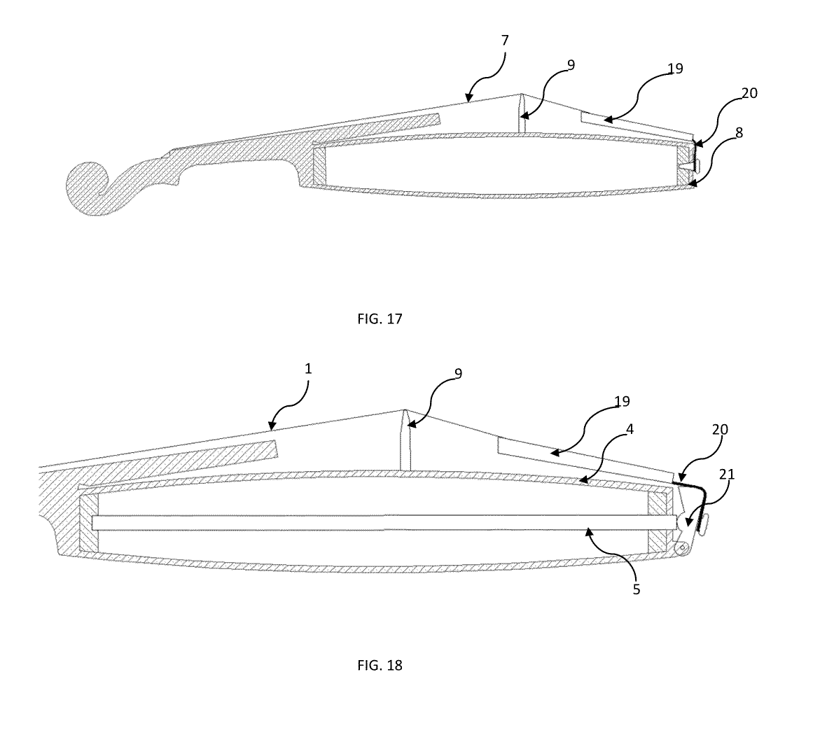

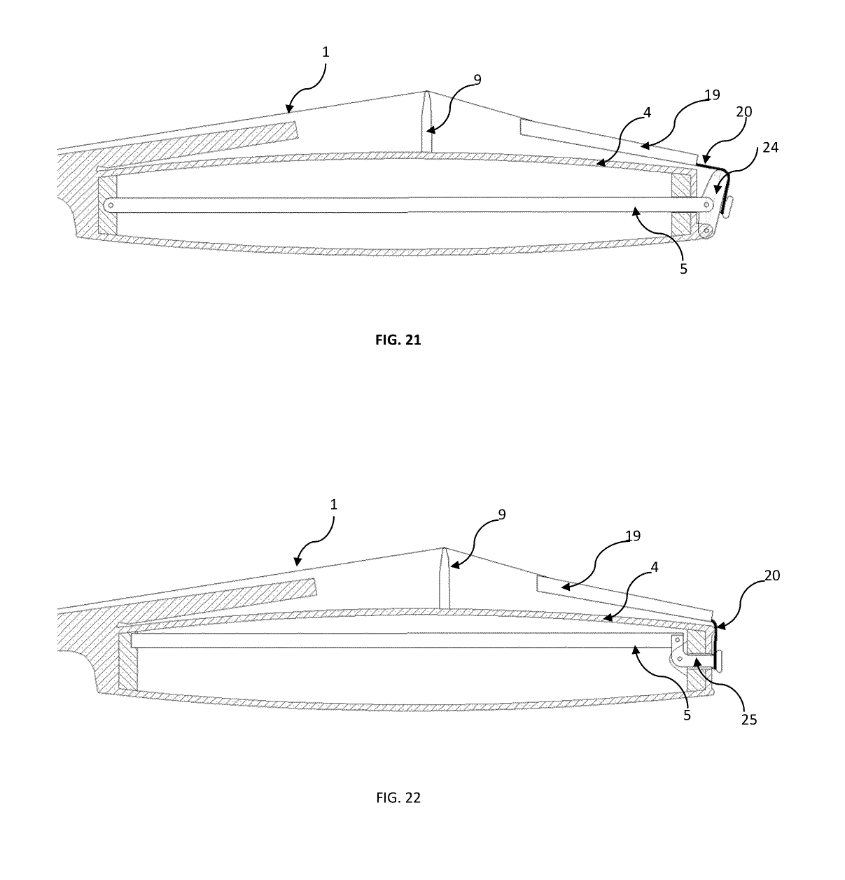

Different compensation mechanisms can be used for violin and similar instruments. FIG. 17 illustrates a standard violin section. Since all the 4 strings are connected to the tail piece 19, in case of manufacturing the strings in a way to have the same thermal expansion coefficient, a proper way can be connecting the compensation mechanism to the tailpiece 19. It's a little complicated because there is a flexible link between the end of tailpiece 19 and the body of the instrument which is called tail gut 20. Different designs can be made. 4 simple examples are brought here. The main issue is making the compensation, but not changing the alignment of the tailpiece. In order to keep the drawings simple, the “sound post” of the violin is not shown here. In case of interference of this part with compensation bar, the compensation bar can be made in 2 branches. FIG. 18, FIG. 20, FIG. 21, and FIG. 22, illustrate different arrangements for connecting the compensation bar 5 to the tail gut 20, in a way to maintain the alignment. As is clearly shown on the drawings, the connection is made by employing additional linkages 21, 22, 23, 24, and 25.

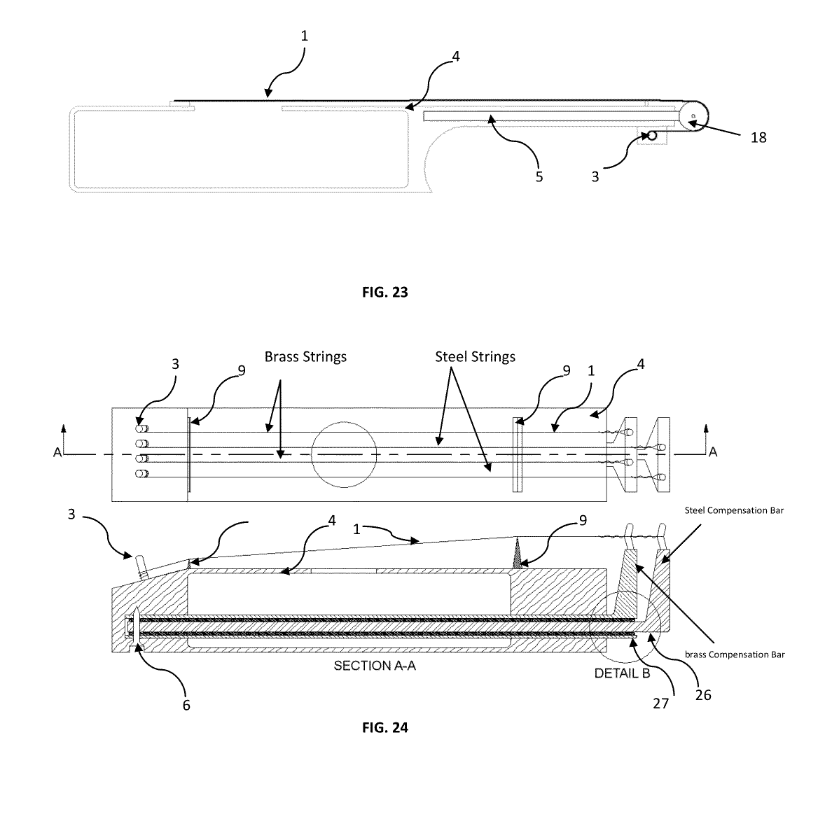

Using compensation mechanism with pulley system: Pulley system can provide an increased transfer ratio of 2:1 for the compensation mechanism. An example is shown above. Pulley solution can be used for different stringed instruments. FIG. 23 is just schematic and not in actual dimensions. Guitar is a very complicated instrument for compensation. One end of the strings is connected on the box, where its not very easy to fit a compensation mechanism without affecting the instrument's sound quality. Also the strings have different lengths and different thermal expansion co-efficient. In order to avoid multiple compensation bars, all the strings should be chosen the way to have equal (Length)×(thermal expansion co-efficient) amount. Only in this case, all the pulleys 18 can be mounted on the same compensation bar 5. Only one string is shown on the FIG. In any case, 1:1 ration compensation bar can also be used for an instrument like guitar by extending the compensation bar inside the sound box.

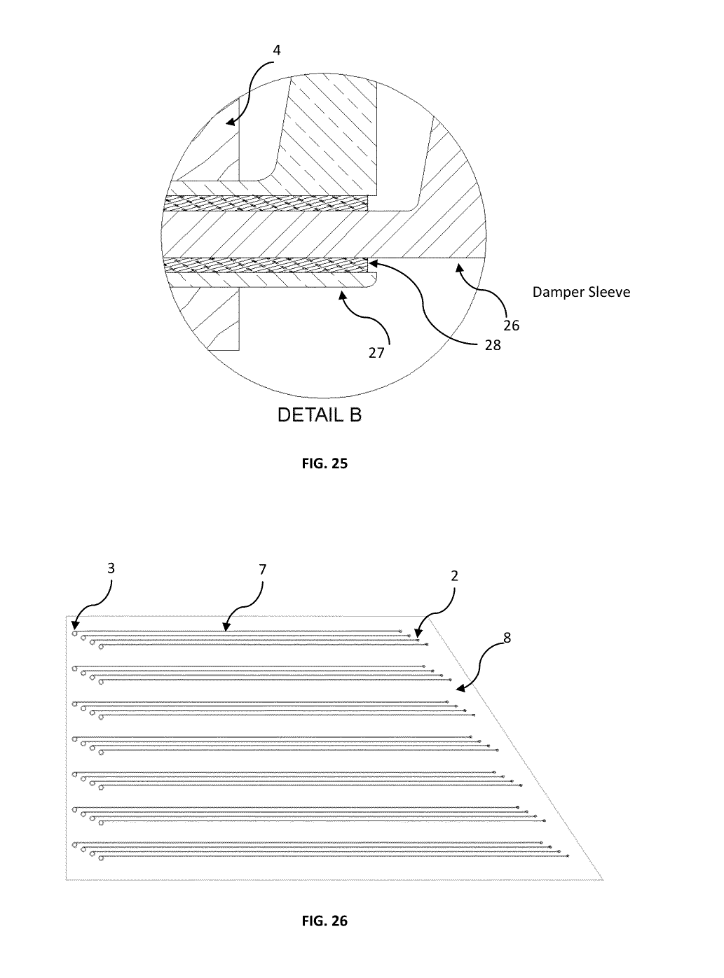

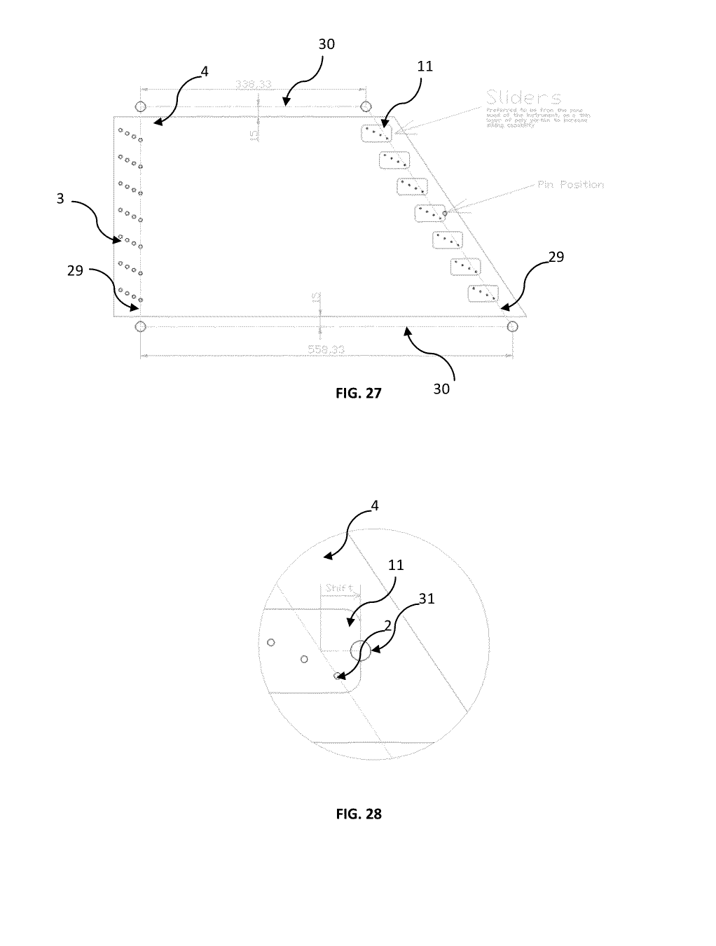

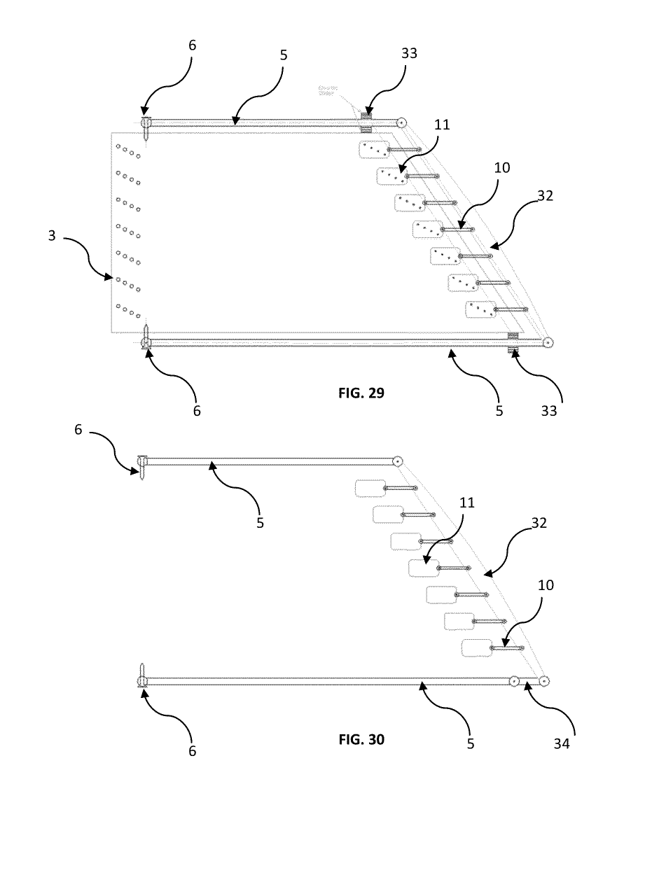

In some cases it may be required to employ multiple compensation bars of different materials. For example when an instrument has strings of both brass and steel, it may be required to have one compensation bar for brass strings, and another one for the steel strings. According to the geometry of the instrument, there can be parallel bars, or even a concentric solution. FIG. 24, and FIG. 25 schematically show concentric compensation solution. This instrument is not an actual instrument and is just a schematic view of this kind of compensation. The inner compensation bar 26, and the outer tube shaped compensation component 27, are separated by a damping sleeve 28.

In many cases, all of the strings of an instrument are not from the equal length. Even in such situations, usage of the compensation mechanism is still possible. FIG. 26 illustrates such an instrument, where the strings have a trapezoid shaped arrangement. The following instructions help to make the right compensation mechanism:

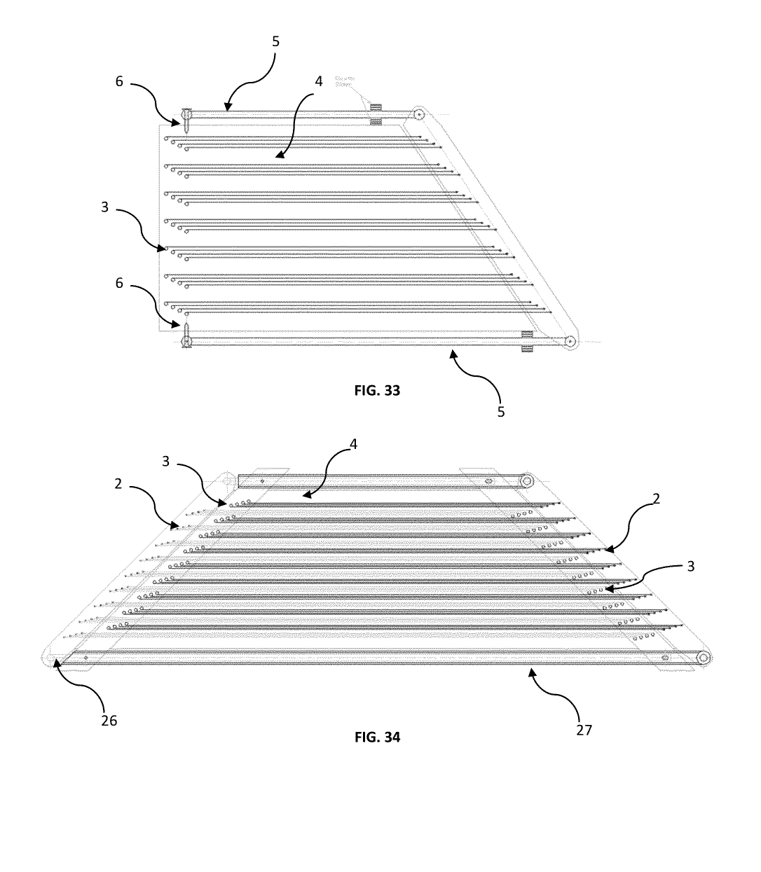

FIG. 27, illustrates a method for obtaining the dimensions of the components. At least 2 compensation bars are required for the instruments with non equal strings in trapezoid shaped arrangement. The guidelines 29 are drawn from each end of the strings or string sets. The compensation bars centerlines can be chosen at any line parallel to the bases of the trapezoid shaped by the strings. The guidelines 29 and the compensation bars centerline 30 form a compensation trapezoid. Each compensation trapezoid base can be used to make one compensation bar. The part of the centerlines 30 between the guidelines 29 is named L_{1.B}. If the strings are perfectly parallel to the compensation bar at both ends and L_{1.wood}=L_{1.string}, then L_{1.B} is equal to L_{1.Bar}. If not, then the effective length of compensation bar (L_{1.bar}) is calculated using the following formula: L_{1.bar}=L_{1.8}×L_{1.string}/L_{1.wood}. The length difference between L_{1.B} and L_{1.Bar} should be added to the other side of the compensation bar, than the side connected to the compensation bar. According to the geometry of the instrument, the bridge centerline can be chosen on the guidline, or be shifted out of the trapezoid at any line parallel (or nearly parallel) to the guidelines 29. Then the compensation bars 5, strings/connecting rods will be extended to reach the compensation bridge centerline. When the connection rods, strings, and compensation bars have the same thermal expansion coefficient, and the string ends are parallel to the compensation bar, the bridge can be not parallel with the guidelines!! In any case the whole mechanism shapes a trapezoid which keeps the strings/rods tension unchanged. If slider solution is chosen, and one slider is used for each set of uni-tune strings, all the strings of the set should have exactly the same length for better results. If there is one string for each note, the guidelines 29 should cross from the both ends of each string. If there are more than one string for each note, one of the strings (First, second, etc.) of each set can be chosen. In any case, the guidelines 29 should be straight. If the length difference of the strings is not linear, the distance between the sets of strings can be modified, in order to keep the guidelines straight. Another solution is to put one end of the strings on one straight guideline (Like the lower end of a harp strings) and put the compensation bar at the other end when the string ends or not on one line. In order to draw the compensation bridge side centerline we can consider only the longest, and the shortest set of the strings, and make the trapezoid. Since the strings/rods extension to the bridge makes a complete trapezoid, the outcome will make a perfect compensation. The whole compensation mechanism can be shifted to the right or left in the direction of the centerline when needed. FIGS. 26˜27, show the compensation bars, shifted to the right, until one end of them is located on the centerline of the pins of the sliders 31. Then, the length of the connection rods 10 is added to the length of the compensation bars. If an instrument has strings from 2 different materials, different sets of compensation mechanisms should be located for each set of strings. An example is Persian santour of the FIG. 34.

Mechanism with sliders, a compensation bridge and connecting rods (FIGS. 27˜30): This mechanism is based on having a bridge 32, to connect the ends of the compensation bars 5. The sliders 11 are connected to the bridge 32 with connecting rods 10. On these figures connecting rods all have the same length. And then the same length should be added to both compensation bars. The longer compensation bar will have higher thermal expansion. So the bridge is not going to remain parallel guideline. So the material for the bridge should be chosen in order to have the same vertical image (cosine of angle) with the closest guideline at any temperature. Since a perfect match is not possible to be found, both compensation bars should be kept in elastic sliders 33 as shown in FIG. 29 or a linked compensation bar extension 34 can be used. It is possible also to use more than 2 compensation bars, as it shown in FIG. 31.

In case of not using elastic sliders, also solutions shown on FIG. 30 and FIG. 31 can be used.

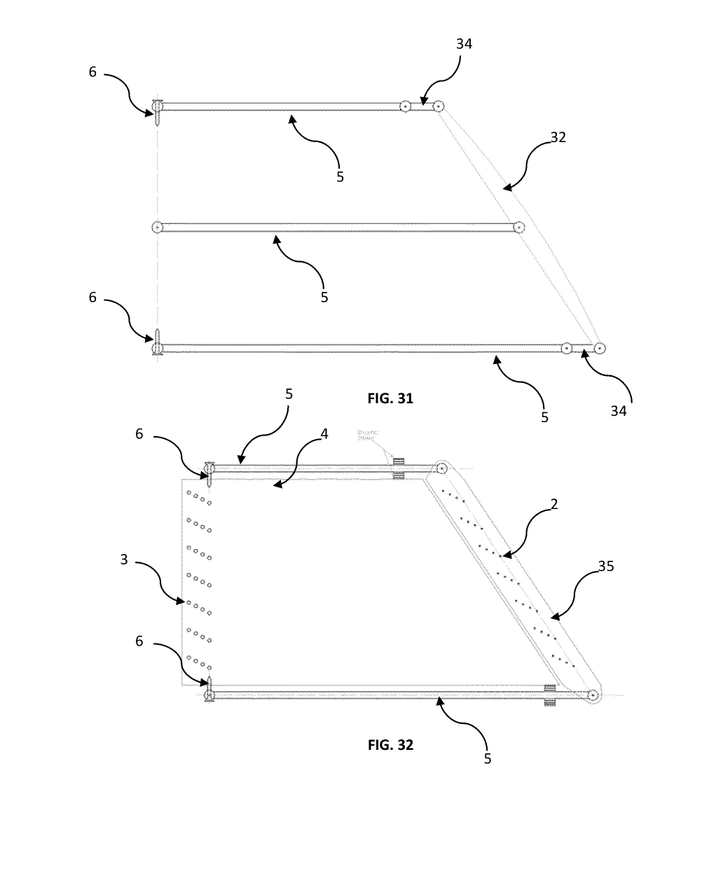

Also one end of the strings can be connected directly on the bridge 35 as of the FIG. 32. This bridge can be made of a composite of wood and reinforcing metal. For this example, since the lower bar will have higher change of length, the set of 4 string will not experience the same compensation. In fact in a set of 4 strings with the same length, the ones closer to the longer compensation bar, will experience more tension than the ones closer to the smaller compensation bar. Well it's obvious that this difference rarely goes over 0.2 mm. It can be considered negligible and in 99% of the cases, the effect is lower than the jnd.

FIG. 34 shows an example of compensation bars for the Persian santour. This instrument has 2 sets of string of steel and brass. The suggested mechanism has one compensation bridge on right for steel strings. And another one on left for the brass strings. The compensation mechanisms are concentric and are pinned to the instrument's body on proper points. The space between 2 bodies is filled with an elastic sleeve which acts as damper. At the screw 6 position of the each compensation mechanism, the other one has a slot 36 to guarantee required degree of freedom for linear thermal expansion. This instrument can also be equipped with bridge-slider solution, or 3 compensation bars for each mechanism according to its construction.

Using another material for compensation bar: It is possible to use another material than the strings for the compensation bar, in case of following this equation:

L_{string}×α_{L-string}=L_{bar}×α_{L.bar}×transfer ratio

L_{1.string}·α_{L.string}=(L_{1.wood}−L_{1.bar})·α_{L.wood}+L_{1.bar}·α_{L.bar}·i

This formula is valid for all the homogenous isotropic materials. In case of the materials those do not have the same module of elasticity under tension and pressure, the formula should be amended as following:

L_{1.string}·α_{L.string}·E_{tension.string}=(L_{1.wood}−L_{1.bar})·α_{L.wood}·E_{pressure.wood}+L_{1.bar}·α_{L.bar}·i·E_{pressure.bar}

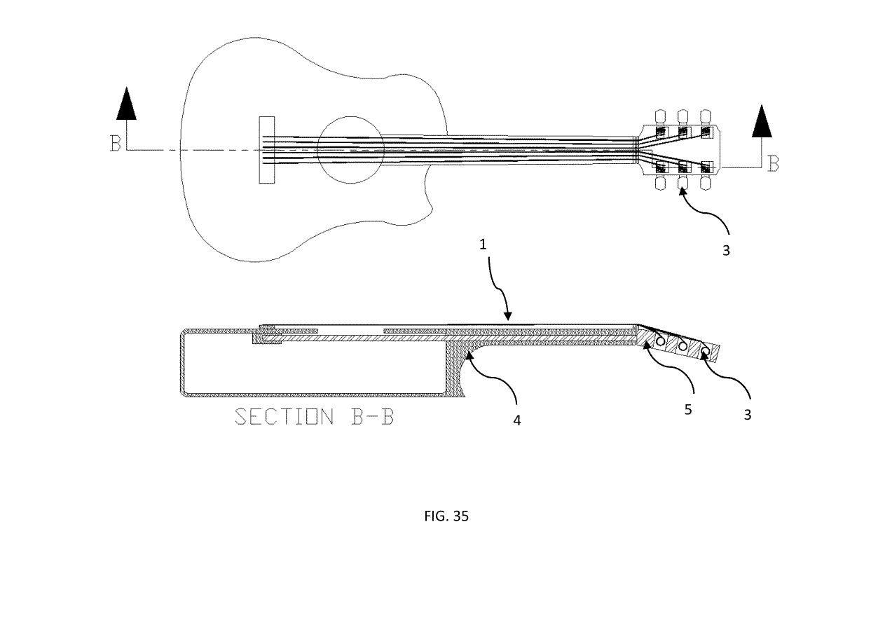

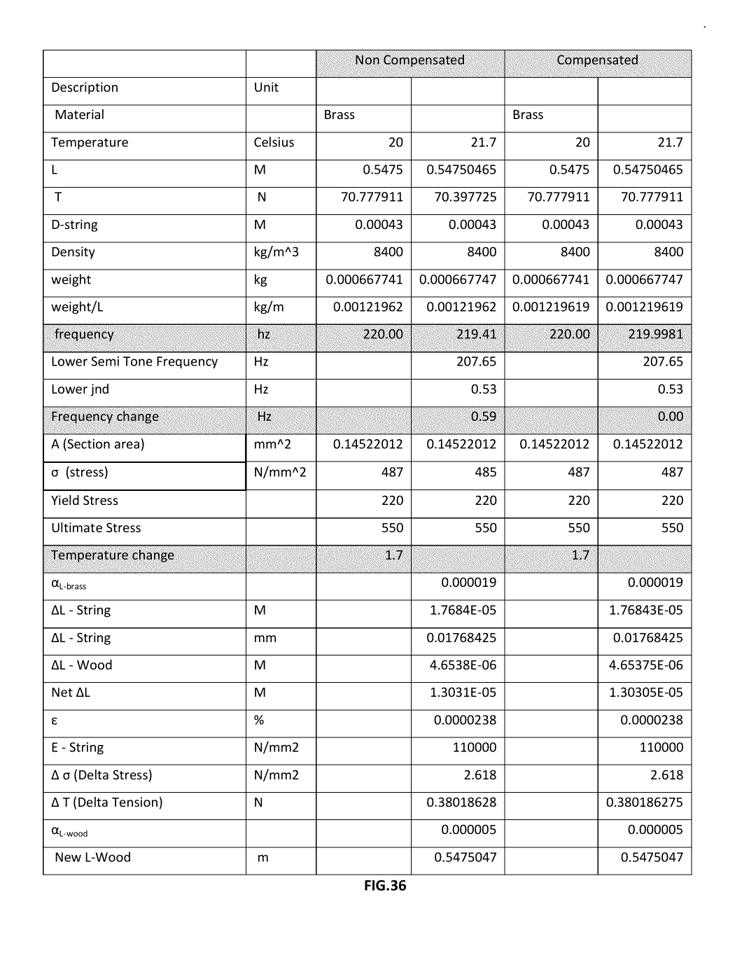

FIG. 35 shows a musical instrument which has unequal strings, but strings are connected to different spots of the compensation bar. So one compensation bar, does the compensation for various unequal length strings. The shown instrument is a guitar like instrument, whereas the compensation bar 5 holds the pegs 3, and the rod shape body of it goes all the way through the neck and gets connected to the underside of the front panel of the instrument body 4, close to the strings 1.

1. The concept of temperature and humidity effect elimination for stringed musical instruments, whereas by the use of one or multiple compensation bars (claim 2) and if required by employing the right linkages, mechanisms, and compensation bridge(s), the tension of the strings is kept at a constant level at any temperature and humidity level, and consequently, the frequency remains nearly unchanged.

2. A compensation bar for a stringed musical instrument, which is a bar that is free to expand or contract by the effect of the temperature change, whereas the expansion or contraction of the compensation bar is aimed to compensate the thermal expansion or contraction effect of one or a set of the strings, and at the meantime keeps the strings tension independent of humidity change.

3. A compensation bridge for a stringed musical instrument, which is a linkage to connect 2 or more compensation bars (the subject of claim 2), in order to provide the possibility of connecting multiple strings of different lengths directly or by the use of sliders and connecting rods to a compensation mechanism with limited number of compensation bars.

4. Method of temperature and humidity effect elimination (claim 1) using direct mounted compensation bar or bars with ratio 1:1 and without any mechanism to keep the tune of one or a set of strings unchanged.

5. Method of temperature and humidity effect elimination (claim 1) for 2 or more sets of strings made of different materials, whereas different compensation bars are chosen for as many sets of strings, to be mounted in parallel or co-centric configuration.

6. Trapezoid shaped temperature and humidity effect elimination (claim 1) solution for strings with the same coefficient of thermal expansion, but with different lengths, whereas the strings can be placed in Trapezoid shaped arrangement, or nearly trapezoid shape with arc shaped leg(s), with 2 or more compensation bars parallel to the bases of trapezoid, and a bridge parallel or nearly parallel with one leg, and strings or connecting rods extended to the bridge centerline.

7. Method of temperature and humidity effect elimination (claim 1) whereas the musical instrument has 2 sets of strings, made of different materials, and each set of strings is consisted of numerous strings of unequal lengths, using two trapezoid shaped compensation mechanisms.

8. Subject of claim 7 whereas compensation bars of two mechanisms are mounted in concentric configuration.

9. Method of temperature and humidity effect elimination (claim 1) whereas the instrument's strings have unequal lengths and are connected to different spots of the same compensation bar.
